(19) United States
(12) Patent Application Publication
(10) Pub. No.: US 2025/0246827 A1
(43) Pub. Date: Jul. 31, 2025

(54) WIRE HARNESS

(71) Applicant: Yazaki Corporation, Tokyo (JP)

(72) Inventors: Toshiharu TAKAHASHI, Shizuoka (JP); Takashi Matsunaga, Shizuoka (JP); Keigo Tsubo, Shizuoka (JP); Masayoshi Takayanagi, Shizuoka (JP); Shingo Hamada, Tokyo (JP); Daiki Amemiya, Tokyo (JP); Kenji Kajikawa, Tokyo (JP)

(73) Assignee: Yazaki Corporation, Tokyo (JP)

(21) Appl. No.: 19/016,083

(22) Filed: Jan. 10, 2025

(30) Foreign Application Priority Data
Jan. 31, 2024 (JP) 2024-012800

(51) Int. Cl. H01R 12/62; H01R 12/58

(52) U.S. Cl. CPC H01R 12/62; H01R 12/585; H01R 2201/26

(57) ABSTRACT

A wire harness includes: a connector including a plurality of terminals having press-fit portions, and a terminal holding part that holds the plurality of terminals arranged in at least one row in a state where the press-fit portions protrude therefrom; and a first planar routing member including a flat plate-shaped first flexible printed board part having flexibility, and a flat plate-shaped first rigid board part connected to one end of the first flexible printed board part, having higher rigidity than the first flexible printed board part, and having a plurality of first through holes formed therein to allow the press-fit portions of the terminals corresponding to the plurality of first through holes to be press-fitted into the plurality of first through holes, respectively.

### CROSS-REFERENCE TO RELATED APPLICATION(S)

The present application claims priority to and incorporates by reference the entire contents of Japanese Patent Application No. 2024-012800 filed in Japan on Jan. 31, 2024.

### BACKGROUND OF THE INVENTION

### 1. Field of the Invention

The present invention relates to a wire harness.

### 2. Description of the Related Art

Conventionally, a rigid-flexible board in which a flexible printed board part having flexibility and a rigid board part on which an electronic component is mounted are integrated has been known. Japanese Patent Application Laid-open No. 2021-036502 discloses a cable connection structure including a flexible printed board, a housing, a cover, and an elastic member. In Japanese Patent Application Laid-open No. 2021-036502, the elastic member is disposed on each of the front and back surfaces of the flexible printed board at a position separated away from a pin terminal in an extending direction of the flexible printed board, and tightly adheres to the flexible printed board by being sandwiched together with the flexible board by the cover and the housing. With this configuration, the cable connection structure in Japanese Patent Application Laid-open No. 2021-036502 can sufficiently suppress a load caused by an external force on the electrical connection portion of the flexible printed circuit board and the pin terminal of the housing.

The flexible printed board part may be electrically connected to the terminal by soldering. Such a configuration has problems that carbon dioxide is generated due to the soldering, and there is difficulty in recycling because the soldering makes it difficult to decompose a connected portion. Therefore, there is a demand for a wire harness capable of reducing the load on the environment.

### SUMMARY OF THE INVENTION

An object of the present invention is to provide a wire harness capable of reducing the load on the environment.

In order to achieve the above mentioned object, a wire harness according to one aspect of the present invention includes a connector including a plurality of terminals having press-fit portions, and a terminal holding part that holds the plurality of terminals arranged in at least one row in a state where the press-fit portions protrude therefrom; and a first planar routing member including a flat plate-shaped first flexible printed board part having flexibility, and a flat plate-shaped first rigid board part connected to one end of the first flexible printed board part, having higher rigidity than the first flexible printed board part, and having a plurality of first through holes formed therein to allow the press-fit portions of the terminals corresponding to the plurality of first through holes to be press-fitted into the plurality of first through holes, respectively.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a wire harness according to an embodiment;

FIG. 2 is a perspective view illustrating a terminal according to the embodiment;

FIG. 3 is a plan view illustrating the wire harness according to the embodiment;

FIG. 4 is a cross-sectional view illustrating the wire harness according to the embodiment;

FIG. 5 is an enlarged cross-sectional view illustrating the wire harness according to the embodiment;

FIG. 6 is a perspective view illustrating a terminal accommodating step in the embodiment;

FIG. 7 is a perspective view illustrating a housing accommodating step in the embodiment;

FIG. 8 is a perspective view illustrating a terminal press-fitting step in the embodiment;

FIG. 9 is a perspective view illustrating a cover attaching step in the embodiment; and

FIG. 10 is a perspective view illustrating a lever attaching step in the embodiment.

### DETAILED DESCRIPTION OF THE PREFERRED EMBODIMENTS

Hereinafter, a wire harness according to an embodiment of the present invention will be described in detail with reference to the drawings. Note that the present invention is not limited by the present embodiment. In addition, the components in the following embodiment include those that can be easily imagined by those skilled in the art or those that are substantially the same.

### Embodiment

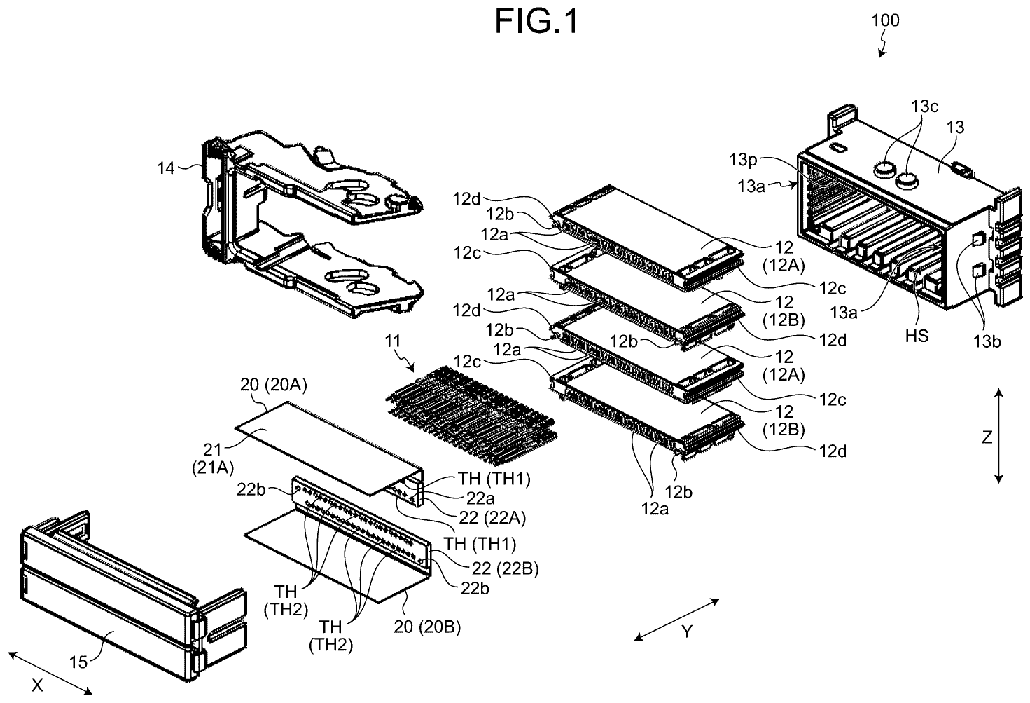

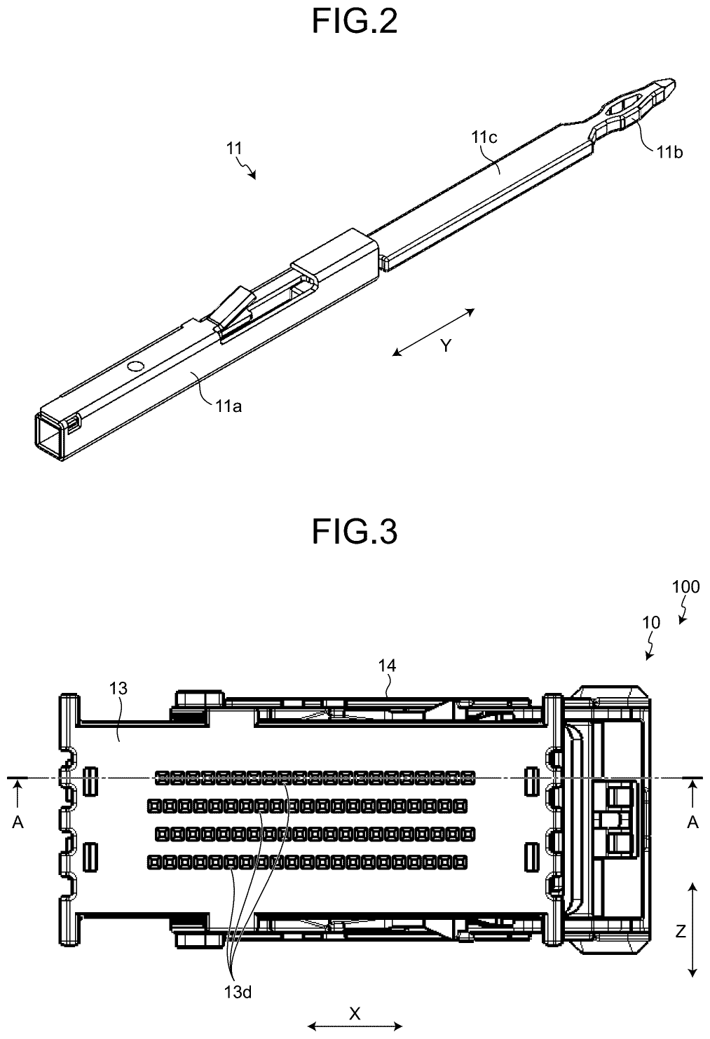

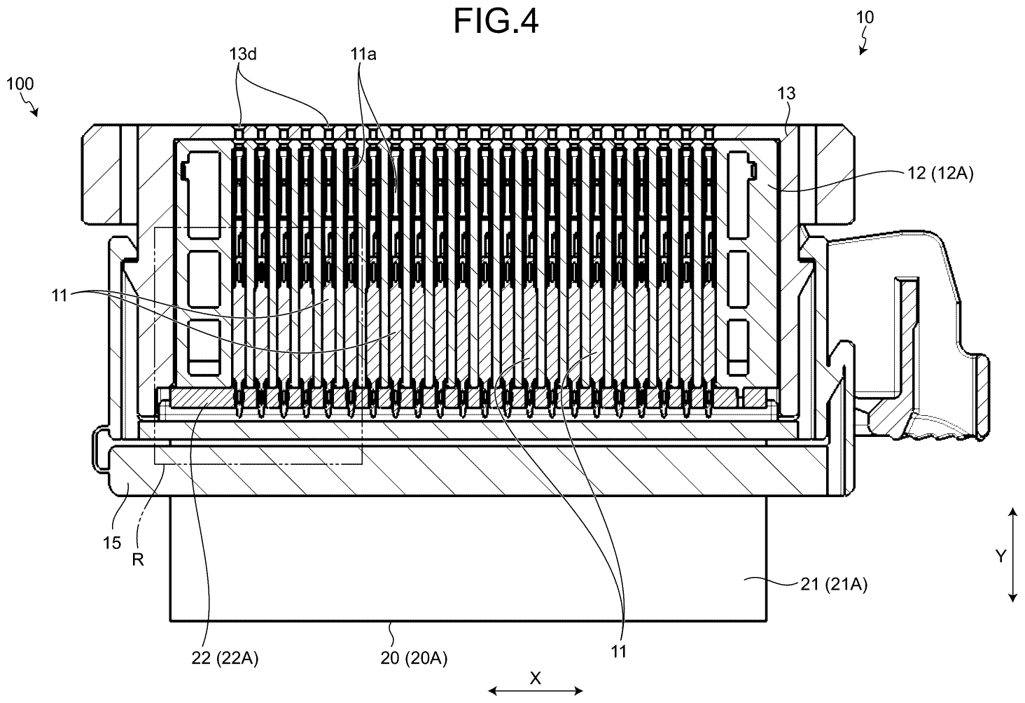

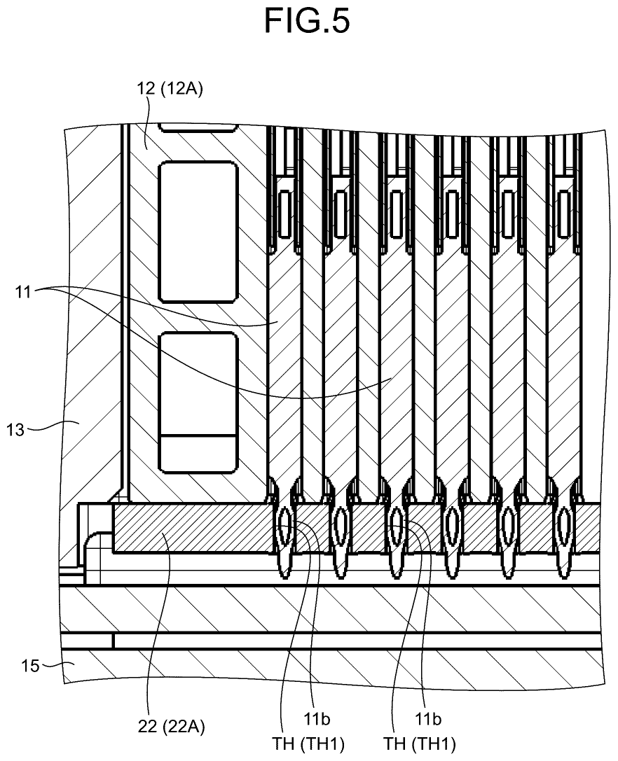

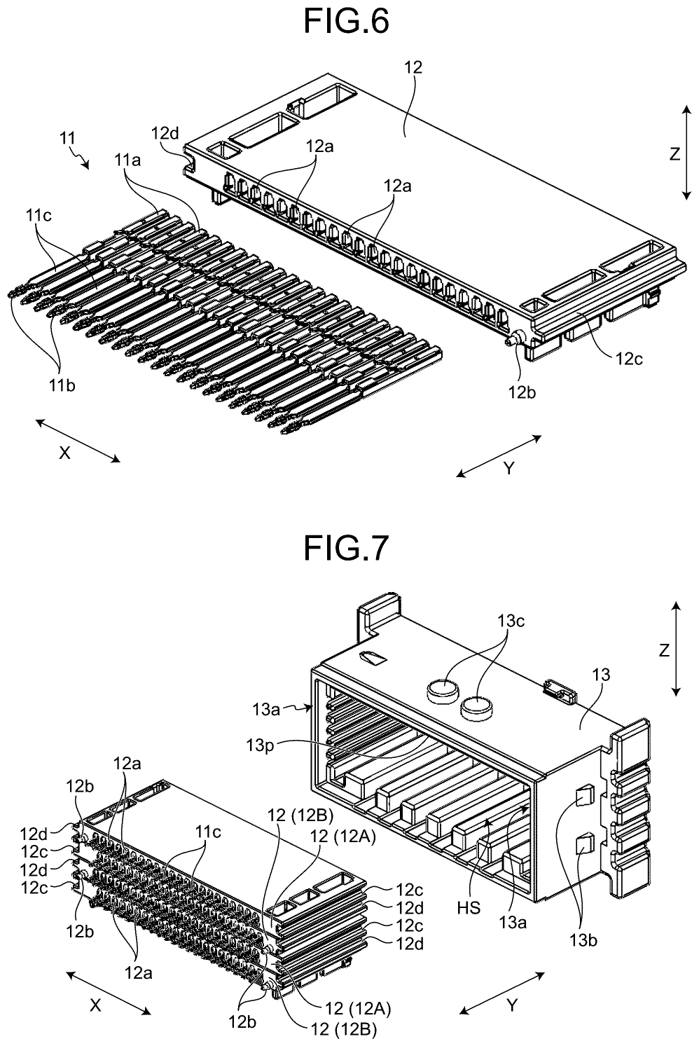

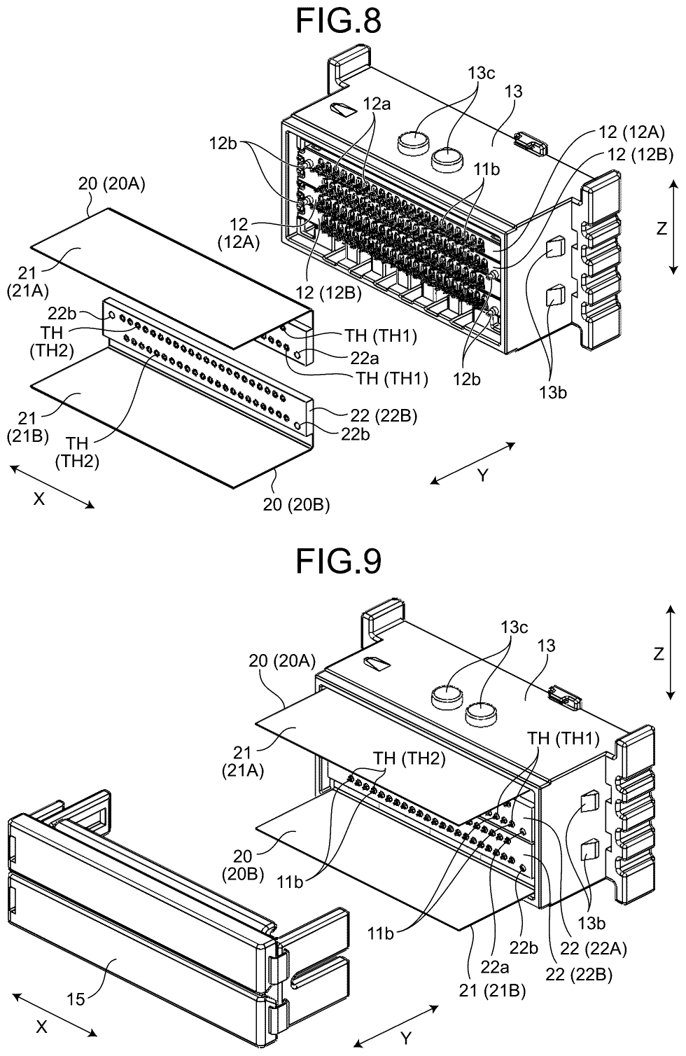

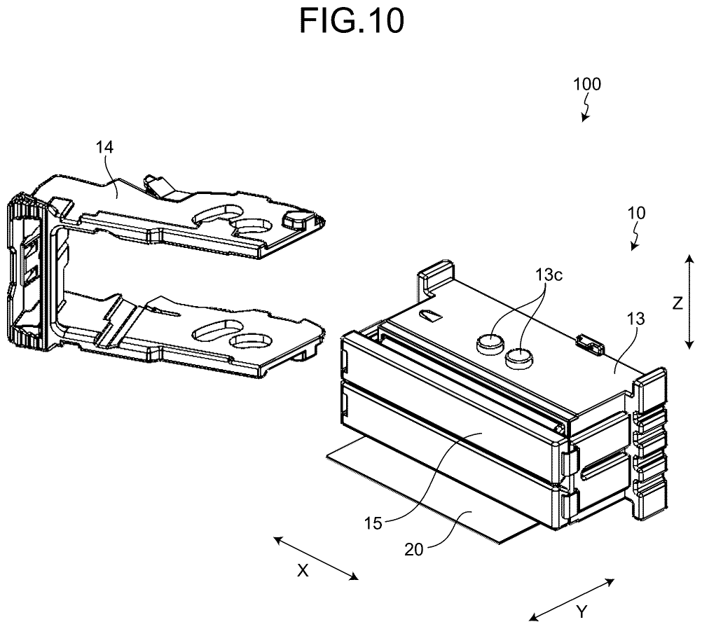

An embodiment will be described with reference to FIGS. 1 to 10. FIG. 1 is a perspective view illustrating a wire harness according to the embodiment, FIG. 2 is a perspective view illustrating a terminal according to the embodiment, FIG. 3 is a plan view illustrating the wire harness according to the embodiment, FIG. 4 is a cross-sectional view illustrating the wire harness according to the embodiment, FIG. 5 is an enlarged cross-sectional view illustrating the wire harness according to the embodiment, FIG. 6 is a perspective view illustrating a terminal accommodating step in the embodiment, FIG. 7 is a perspective view illustrating a housing accommodating step in the embodiment, FIG. 8 is a perspective view illustrating a terminal press-fitting step in the embodiment, FIG. 9 is a perspective view illustrating a cover attaching step in the embodiment, and FIG. 10 is a perspective view illustrating a lever attaching step in the embodiment. FIG. 4 is a cross-sectional view taken along line A-A illustrated in FIG. 3, and FIG. 5 is an enlarged cross-sectional view of region R illustrated in FIG. 4.

A wire harness 100 according to the embodiment illustrated in FIG. 1 is mounted on, for example, a vehicle such as an automobile, and electrically connects an electric device of the vehicle to another electric device or the like of the vehicle. As illustrated in FIG. 2, the wire harness 100 according to the embodiment includes a connector 10 and a planar routing member 20.

The connector 10 is fitted to a mating connector (not illustrated). For example, the mating connector is disposed in a housing of a device such as a display or a meter device. The wire harness 100 connects, for example, a device having a mating connector and a control device that controls the device. The planar routing member 20 includes a printed circuit including a power supply line and a signal line.

The connector 10 includes a terminal 11, a terminal holding part 12, a housing 13, a lever 14, and a cover 15.

As illustrated in FIG. 2, the terminal 11 is a metal press-fit terminal. The terminal 11 includes a square tube-shaped electrical connection portion 11a provided at one end portion in the axial direction of the terminal 11, a press-fit portion 11b provided at the other end portion in the axial direction of the terminal 11, and a flat plate-shaped wide portion 11c connecting the electrical connection portion 11a and the press-fit portion 11b. The terminal 11 is formed in a linear shape in which the electrical connection portion 11a, the press-fit portion 11b, and the wide portion 11c are connected to each other along the axial direction that is a direction in which the terminal 11 is press-fit into a through hole TH to be described below.

The press-fit portion 11b has a central hole penetrating the press-fit portion 11b in a direction orthogonal to the axial direction. When viewed from the direction in which the central hole penetrates the press-fit portion 11b, the central hole is formed in a rectangular shape that is horizontally elongate in the axial direction. The press-fit portion 11b has a pair of press-fit deformation portions provided to sandwich the central hole therebetween, and the pair of press-fit deformation portions are formed to be deformable so as to bend toward the central hole by receiving a force from an outer peripheral portion of the through hole TH when the press-fit portion 11b is press-fitted into the through hole TH. In the terminal 11, the portions where the pair of press-fit deformation portions are provided are pressure contact portions are brought into pressure contact with the through hole TH.

As illustrated in FIG. 1, the terminal holding part 12 is a member that accommodates terminals 11, and is molded from an insulating material such as a resin. A plurality of terminal accommodation holes 12a are formed in one side surface 12s of the terminal holding part 12 of the embodiment. The terminal accommodation holes 12a penetrate the terminal holding part 12 in a direction in which the connector 10 is fitted to a mating connector. In the terminal holding part 12 of the embodiment, the plurality of terminal accommodation holes 12a are formed in a plurality of rows, and the plurality of terminal accommodation holes 12a in one of the rows adjacent to each other are formed to be shifted in the row direction of the plurality of terminal accommodation holes 12a with respect to the plurality of terminal accommodation holes 12a in the other one of the rows adjacent to each other. That is, the plurality of terminal accommodation holes 12a are arranged in a staggered manner.

In the terminal holding part 12, the terminals 11 are accommodated in the terminal accommodation holes 12a on a one-to-one basis, and the press-fit portions 11b protrude from the terminal accommodation holes 12a. That is, the terminal holding part 12 holds the plurality of terminals 11 arranged in a plurality of rows in a state where the press-fit portions 11b protrudes therefrom. In the embodiment, the terminal holding part 12 holds the plurality of terminals 11 arranged in such a manner that the plurality of terminals 11 in one of the rows adjacent to each other are shifted in the row direction of the plurality of terminals 11 with respect to the plurality of terminals 11 in the other one of the rows adjacent to each other. That is, the plurality of terminals 11 are arranged in a staggered manner by being inserted into the corresponding terminal accommodation holes 12a of the terminal holding part 12.

In the embodiment, the terminal holding part 12 includes a plurality of flat plate parts 12A and a plurality of flat plate parts 12B having a flat plate shape. The terminal holding part 12 of the embodiment is configured by alternately stacking two flat plate parts 12A and two flat plate parts 12B in a plate thickness direction of the flat plate parts 12A and 12B. In a side surface of each of the flat plate parts 12A and 12B, the plurality of terminal accommodation holes 12a penetrating each of the flat plate parts 12A and 12B in a protruding direction in which the press-fit portions 11b protrude from the terminal holding part 12 are arranged in a row in a direction orthogonal to the protruding direction.

In the following description, the row direction in which the terminals 11 are arranged in a row in each of the flat plate parts 12A and 12B of the terminal holding part 12 will be referred to as a “first direction X”. The protruding direction in which the press-fit portions 11b of the terminals 11 protrude from the terminal holding part 12 will be referred to as a “second direction Y”. The stacking direction in which the flat plate parts 12A and 12B of the terminal holding part 12 are stacked will be referred to as a “third direction Z”. In the embodiment, the first direction X, the second direction Y, and the third direction Z are orthogonal to each other. The first direction X corresponds to a width direction of the connector 10. The second direction Y corresponds to a fitted direction between the connector 10 and the mating connector. The third direction Z corresponds to a height direction of the connector 10.

The terminal holding part 12 of the embodiment is formed such that, when the flat plate parts 12A and 12B are stacked such that the surfaces in which the terminal accommodation holes 12a are formed (the surfaces from which the press-fit portions 11b of the terminals 11 protrude) face the same direction, the terminal accommodation holes 12a of the flat plate parts 12A and the terminal accommodation holes 12a of the flat plate parts 12B are arranged in a staggered manner in an end surface of the terminal holding part 12 (a surface in which the terminal accommodation holes 12a are formed). That is, when the flat plate parts 12A and 12B are stacked such that the surfaces in which the terminal accommodation holes 12a are formed face the same direction, the plurality of terminal accommodation holes 12a of the flat plate parts 12A are arranged at positions to be shifted in the first direction X with respect to the plurality of terminal accommodation holes 12a of the flat plate parts 12B.

A concave portion 12c to be fitted onto an uneven surface 13a formed on one of the inner side surfaces of the housing 13 to be described below is formed on one side surface of the flat plate part 12A in the first direction X, and a convex portion 12d to be fitted onto an uneven surface 13a formed on the other one of the inner side surfaces of the housing 13 to be described below is formed on the other side surface of the flat plate part 12A in the first direction X. The flat plate part 12A is held by the housing 13 by fitting the convex portion 12d and the concave portion 12c onto the uneven surfaces 13a of the inner side surfaces of the housing 13.

A support protrusion 12b is formed on an end surface of the flat plate part 12A from which the press-fit portion 11b protrudes. The support protrusion 12b is a portion inserted into a through hole (a through hole 22a or a through hole 22b) of a rigid board part 22 to be described below. On the end surface of the flat plate part 12A on the side where the press-fit portion 11b protrudes, the support protrusion 12b is formed on the other end portion in the first direction X (the end portion of the flat plate part 12A on the convex portion 12d side).

A convex portion 12d to be fitted onto an uneven surface 13a formed on one of the inner side surfaces of the housing 13 to be described below is formed on one side surface of the flat plate part 12B in the first direction X, and a concave portion 12c to be fitted onto an uneven surface 13a formed on the other one of the inner side surfaces of the housing 13 to be described below is formed on the other side surface of the flat plate part 12B in the first direction X. Similarly to the flat plate part 12A, the flat plate part 12B is also held by the housing 13 by fitting the convex portion 12d and the concave portion 12c onto the uneven surfaces 13a of the inner side surfaces of the housing 13.

A support protrusion 12b is also formed on an end surface of the flat plate part 12B from which the press-fit portion 11b protrudes. Similarly to the support protrusion 12b of the flat plate part 12A, the support protrusion 12b of the flat plate part 12B is also a portion inserted into a through hole (a through hole 22a or a through hole 22b) of a rigid board part 22 to be described below. On the end surface of the flat plate part 12B on the side where the press-fit portion 11b protrudes, the support protrusion 12b is formed at one end portion in the first direction X (the end portion of the flat plate part 12B on the concave portion 12c side).

The housing 13 is a member that accommodates the terminal holding part 12, and is formed of an insulating material such as a resin. The housing 13 of the embodiment is formed in a box shape while being open on the side toward which the press-fit portions 11b of the terminals 11 protrude, and includes a housing space HS that holds the flat plate parts 12A and 12B constituting the terminal holding part 12 in a stacked state inside. The terminal holding part 12 (the flat plate parts 12A and 12B) is inserted from an opening 13p of the box-shaped housing 13, and the terminals 11 are held in a state where the press-fit portions 11b protrude from the opening 13p of the housing 13. As illustrated in FIG. 3, the housing 13 has a plurality of mating terminal insertion holes 13d formed in a surface of the housing 13 opposite to the opening 13p to allow terminals of a mating connector to be inserted thereinto. In the housing 13, the mating terminal insertion holes 13d are formed at positions corresponding to the positions of the electrical connection portions in the plurality of terminals 11, respectively.

The lever 14 is a portion attached to the housing 13 to fit the housing of the connector 10 to a housing of a mating connector by a booster mechanism including the lever 14. That is, the lever 14 is a portion that amplifies a force input to the lever 14, and fits the housing 13 to a mating connector with the amplified force being transmitted to the mating connector. The housing 13 has two wall portions disposed at positions between which the flat plate parts 12A and 12B in the housing space HS are sandwiched in the stacking direction (the third direction Z) of the flat plate parts 12A and 12B. A cylindrical shaft part 13c is formed on each of the outer side surfaces of the two wall portions of the housing 13. The shaft part 13c rotatably supports the lever 14.

As illustrated in FIG. 1, the planar routing member 20 is a rigid-flexible board including a flexible printed board part 21 and a rigid board part 22. The flexible printed board part 21 is a flat plate-shaped circuit body having flexibility. The rigid board part 22 is a flat plate-shaped member having higher rigidity than the flexible printed board part 21 and connected to one end of the flexible printed board part 21. Here, the rigid board part 22 is, for example, a hard printed wiring board. In the embodiment, one end of the flexible printed board part 21 and one end of the rigid board part 22 are connected to each other, and the planar routing member 20 is configured as a flat plate-shaped circuit board as a whole.

The flexible printed board part 21 includes a base film and a printed circuit printed on the base film. The printed circuit is a plurality of conductive wires linearly drawn out from the rigid board part 22, and is electrically connected to the terminals 11 connected to the rigid board part 22.

A plurality of through holes TH are formed in the rigid board part 22. The rigid board part 22 has through holes 22a and 22b formed at both end portions in the first direction X to allow the support protrusions 12b of the flat plate parts 12A and 12B described above to be inserted therethrough.

The plurality of through holes TH of the rigid board part 22 are formed to correspond to the press-fit portions 11b of the plurality of terminals 11 connected to the rigid board part 22 on a one-to-one basis. For example, the plurality of through holes TH of the rigid board part 22 are connected to the corresponding conductive wires in the printed circuit of the flexible printed board part by a linear conductive wire provided on the rigid board part 22.

In the embodiment, since the plurality of through holes TH are formed in a staggered manner in the rigid board part 22, a large number of through holes TH can be densely formed with respect to the area of the rigid board part 22. Therefore, it is possible to suppress an increase in size of the connector 10 while making the connector 10 multipolar. The terminals 11 arranged at different positions in the third direction Z of the rigid board part 22 and the printed circuit of the flexible printed board part 21 can be electrically connected to each other by a linear conductive wire. Therefore, when wiring is drawn out from the rigid board part 22, the plurality of terminals 11 and the corresponding conductive wires in the printed circuit of the flexible printed board part 21 can be electrically connected to each other by the linear conductive wire without forming a complicated circuit.

Each of the through holes TH includes a tubular electrical connection portion provided on an inner peripheral surface of an opening of each of the through holes TH. The electrical connection portion is formed as a plating layer such as a copper plating layer formed on the inner peripheral surface of the opening of the through hole TH. The electrical connection portion extends from the tubular portion toward the circuit portion of the rigid board so as to be physically and electrically connected to the circuit portion of the rigid board. In the embodiment, the electrical connection portion functions as an inner peripheral surface of the through hole TH. Therefore, in the plurality of through holes TH, the entire inner peripheral surfaces thereof can be used as points that contact the terminals 11.

As illustrated in FIG. 4, each of the electrical connection portions 11a of the plurality of terminals 11 is held to face the corresponding mating terminal insertion hole 13d of the housing 13 in the second direction Y. When the connector 10 is fitted to a mating connector, a mating terminal of the mating connector is inserted into the tubular electrical connection portion 11a of the terminal 11 through the mating terminal insertion hole 13d of the housing 13.

When the mating terminal is inserted into the electrical connection portion 11a of the terminal 11, the terminal 11 and the mating terminal are electrically connected to each other. As illustrated in FIGS. 4 and 5, the press-fit portions 11b of the terminals 11 corresponding to the plurality of through holes TH are press-fitted into the plurality of through holes TH, respectively. The press-fit portion 11b is held at a position in contact with the inner peripheral surface of the through hole TH, and is electrically connected to the inner peripheral surface (the electrical connection portion) of the through hole TH.

The wire harness 100 according to the embodiment includes a pair of planar routing members 20 (a first planar routing member 20A and a second planar routing member 20B). The first planar routing member 20A and the second planar routing member 20B are provided as wiring boards independent from each other.

The first planar routing member 20A includes a first flexible printed board part 21A and a first rigid board part 22A. The first flexible printed board part 21A is a flat plate-shaped circuit body having flexibility. The first rigid board part 22A is a flat plate-shaped member having higher rigidity than the first flexible printed board part 21A and connected to one end of the first flexible printed board part 21A. One end of the first flexible printed board part 21A and one end of the first rigid board part 22A are connected to each other, and the first planar routing member 20A is configured as a flat plate-shaped circuit board as a whole.

The first flexible printed board part 21A includes a base film and a printed circuit printed on the base film. The printed circuit is a plurality of conductive wires linearly drawn out from the first rigid board part 22A, and is electrically connected to the terminals 11 connected to the first rigid board part 22A. A plurality of first through holes TH1 are formed in the first rigid board part 22A. The plurality of first through holes TH1 are formed to correspond to the press-fit portions 11b of the plurality of terminals 11 connected to the first rigid board part 22A on a one-to-one basis.

The second planar routing member 20B includes a second flexible printed board part 21B and a second rigid board part 22B. The second flexible printed board part 21B is a flat plate-shaped circuit body having flexibility. The second rigid board part 22B is a flat plate-shaped member having higher rigidity than the second flexible printed board part 21B and connected to one end of the second flexible printed board part 21B. One end of the second flexible printed board part 21B and one end of the second rigid board part 22B are connected to each other, and the second planar routing member 20B is configured as a flat plate-shaped circuit board as a whole.

The second flexible printed board part 21B includes a base film and a printed circuit printed on the base film. The printed circuit is a plurality of conductive wires linearly drawn out from the second rigid board part 22B, and is electrically connected to the terminals 11 connected to the second rigid board part 22B. A plurality of second through holes TH2 are formed in the second rigid board part 22B. The plurality of second through holes TH2 are formed to correspond to the press-fit portions 11b of the plurality of terminals 11 connected to the second rigid board part 22B on a one-to-one basis.

The plurality of terminals 11 held by the terminal holding part 12 include a first group of terminals arranged on a first side in the third direction Z and a second group of terminals arranged on a second side opposite to the first side in the third direction Z. In the embodiment, the terminals 11 arranged in the third direction Z are arranged in four rows. The first group of terminals has two rows of the terminals 11 on the first side among the rows of the terminals 11 arranged in the third direction Z. The second group of terminals has two rows of the terminals 11 on the second side among the rows of the terminals 11 arranged in the third direction Z.

The press-fit portions 11b of the terminals 11 in the first group of terminals corresponding to the plurality of first through holes TH1 are press-fitted into the plurality of first through holes TH1, respectively, in the first rigid board part 22A, and the press-fit portions 11b of the terminals 11 in the second group of terminals corresponding to the plurality of second through holes TH2 are press-fitted into the plurality of second through holes TH2, respectively, in the second rigid board part 22B. At this time, the first rigid board part 22A and the second rigid board part 22B are disposed adjacent to each other in the third direction. The first flexible printed board part 21A is connected to one end of the first rigid board part 22A on the first side, and extends from the first rigid board part 22A toward the first side. The second flexible printed board part 21B is connected to one end of the second rigid board part 22B on the second side, and extends from the second rigid board part 22B toward the second side.

That is, in the embodiment, the two planar routing members 20 (the first planar routing member 20A and the second planar routing member 20B) are provided adjacent to each other in the third direction z, and in each of the planar routing members 20, the flexible printed board part 21 extends toward the side opposite to the other adjacent planar routing member 20 side.

The cover 15 is a member that covers a joining portion between the rigid board part 22 and the terminals 11 while holding the flexible printed board part 21, and is engaged with the housing 13. The housing 13 has an engagement protrusion 13b on each of the outer side surfaces in the first direction X. The cover 15 has an engagement concave portion to be engaged with the engagement protrusion 13b, and is assembled to the housing 13 by engaging the engagement concave portion with the engagement protrusion 13b of the housing 13.

In the embodiment, the cover 15 includes a main body part, a holding part, and a hinge. The main body part of the cover 15 is a portion that covers a joining portion between the rigid board part 22 and the terminals 11. The holding part is disposed on the side opposite to the joining portion side with respect to the main body, and is connected to the main body part via the hinge. The holding part is a portion that holds the flexible printed board part 21 by sandwiching the flexible printed board part 21 between the main body part and the holding part. In the embodiment, the first flexible printed board part 21A is folded to wrap the main body part of the cover 15, and is held by being sandwiched between the holding part and the main body part while overlapping the second flexible printed board part 21B (see FIG. 10).

Next, a method for manufacturing a wire harness according to the embodiment will be described with reference to FIGS. 6 to 10. The method for manufacturing the wire harness 100 in the embodiment includes a terminal holding step, a housing accommodating step, a press-fitting step, a cover attaching step, and a lever attaching step.

As illustrated in FIG. 6, in the terminal holding step, the terminals 11 corresponding to the plurality of terminal accommodation holes 12a are inserted into the plurality of terminal accommodation holes 12a, respectively, of the terminal holding part 12. Here, each of the terminals 11 is inserted such that the press-fit portion 11b of the terminal 11 protrudes from the end surface exposed from the opening 13p of the housing 13 in the housing accommodating step to be described below. The terminals 11 held by the terminal holding part 12 are arranged such that the leading edge positions of the press-fit portions 11b of the plurality of terminals 11 on the side surface 12s of the terminal holding part 12 are located on the same plane. That is, the press-fit portions 11b of the plurality of terminals 11 held by the terminal holding part 12 are arranged in a state in which their protrusion lengths from the side surface of the terminal holding part 12 are aligned.

Thereafter, as illustrated in FIG. 7, in the housing accommodating step, the terminal holding part 12 is accommodated in the housing 13 in a state where the terminals 11 are held thereby. In the embodiment, the flat plate parts 12A and 12B are inserted into the housing space HS of the housing 13 from the opening 13p of the housing 13 in a state where the flat plate parts 12A and 12B are stacked, thereby holding the flat plate parts 12A and 12B in the housing 13. At this time, the stacked flat plate parts 12A and 12B are inserted such that the concave portions 12c and the convex portions 12d of the flat plate parts 12A and 12B are fitted onto the uneven surfaces 13a of the housing 13.

Thereafter, as illustrated in FIG. 8, in the press-fitting step, the press-fit portions 11b of the terminals 11 are press-fitted into the plurality of through holes TH formed in the rigid board part 22 of the planar routing member 20 to correspond thereto respectively.

In the press-fitting step of the embodiment, the press-fit portions 11b of the terminals 11 corresponding to the plurality of through holes TH are press-fitted into the plurality of through holes TH, respectively, in a state where the two planar routing members 20 (the first planar routing member 20A and the second planar routing member 20B) are arranged adjacent to each other in the third direction Z. That is, the press-fit portions 11b of the terminals 11 corresponding to the plurality of first through holes TH1 are press-fitted into the plurality of first through holes TH1, respectively, of the first rigid board part 22A disposed on the first side in the third direction Z, and the press-fit portions 11b of the terminals 11 corresponding to the plurality of second through holes TH2 are press-fitted into the plurality of second through holes TH2, respectively, of the second rigid board part 22B disposed on the second side opposite to the first side in the third direction z.

At this time, the support protrusion 12b formed at one end of the flat plate part 12A in the first direction X is inserted through the through hole 22a formed at one end portion of the first rigid board part 22A in the first direction X, and the support protrusion 12b formed at the other end of the flat plate part 12B in the first direction X is inserted through the through hole 22a formed at the other end portion of the first rigid board part 22A in the first direction X. Also, the support protrusion 12b formed at one end of the flat plate part 12A in the first direction X is inserted through the through hole 22b formed at one end portion of the second rigid board part 22B in the first direction X, and the support protrusion 12b formed at the other end of the flat plate part 12B in the first direction X is inserted through the through hole 22b formed at the other end portion of the second rigid board part 22B in the first direction X.

In addition, in the press-fitting step of the embodiment, the first flexible printed board part 21A of the first planar routing member 20A is disposed to extend from the first rigid board part 22A toward the first side, and the second flexible printed board part 21B of the second planar routing member 20B is disposed to extend from the second rigid board part 22B toward the second side. In the embodiment, the press-fitting step is performed in a state where the first rigid board part 22A and the second rigid board part 22B are adjacent to each other, so that the terminals 11 can be press-fitted into the two rigid board parts 22 in one step.

Thereafter, as illustrated in FIG. 9, in the cover attaching step, the cover 15 is engaged with and attached to the housing 13. As described above, in the embodiment, the cover 15 includes a main body part, two holding parts, and a hinge. The two holding parts are adjacent to each other in the third direction Z, each of the holding parts being connected to the main body part via the hinge. The holding parts are engaged with the main body part to cover the main body part by bending the hinge. In the cover attaching step, the main body part is attached to cover the two rigid board parts 22, and then the first flexible printed board part 21A is folded to wrap the main body part of the cover 15, and the folded first flexible printed board part 21A is sandwiched between the two holding parts and the main body part, with the first flexible printed board part 21A and the second flexible printed board part 21B being held in an overlapping state.

Thereafter, as illustrated in FIG. 10, in the lever attaching process, the lever 14 is attached to the housing 13. The lever 14 is rotatably attached to the shaft part 13c of the housing 13. Through the above-described steps, the wire harness 100 according to the embodiment is manufactured.

In the above-described embodiment, the plurality of terminal accommodation holes 12a are arranged in a staggered manner in the terminal holding part 12, but the present invention is not limited to this configuration. For example, in the terminal holding part 12, the plurality of terminal accommodation holes 12a may be arranged in a matrix form.

In addition, in the above-described embodiment, the terminal holding part 12 and the housing 13 are separate bodies, but the present invention is not limited thereto. For example, the terminal holding part 12 may be formed integrally with the housing 13.

In the above-described embodiment, the first flexible printed board part 21A is folded to wrap the main body part of the cover 15, and sandwiched between the holding parts and the main body part to hold the first flexible printed board part 21A and the second flexible printed board part 21B in an overlapping state, but the present invention is not limited thereto. For example, the first flexible printed board part 21A and the second flexible printed board part 21B may be folded to wrap the main body part of the cover 15, and sandwiched between the holding parts and the main body part to hold the first flexible printed board part 21A and the second flexible printed board part 21B in a drawn-out state while overlapping each other between the two holding parts.

The number of flat plate parts 12A and 12B constituting the terminal holding part 12 is not limited to four. For example, the terminal holding part 12 may be configured by stacking two flat plate parts 12A and 12B.

The connector 10 may include no lever 14.

As described above, a wire harness 100 according to the embodiment includes: a connector 10 including a plurality of terminals 11 having press-fit portions 11b, and a terminal holding part 12 that holds the plurality of terminals 11 arranged in at least one row in a state where the press-fit portions 11b protrude therefrom; and a first planar routing member 20A including a flat plate-shaped first flexible printed board part 21A having flexibility, and a flat plate-shaped first rigid board part 22A connected to one end of the first flexible printed board part 21A, having higher rigidity than the first flexible printed board part 21A, and having a plurality of first through holes TH1 formed therein to allow the press-fit portions 11b of the terminals 11 corresponding to the plurality of first through holes TH1 to be press-fitted into the plurality of first through holes TH1, respectively.

In the wire harness 100 according to the embodiment, by press-fitting the press-fit portions 11b of the terminals 11 into the first rigid board part 22A of the first planar routing member 20A, the first rigid board part 22A and the terminals 11 can be electrically connected to each other without using solders. With this configuration, for example, the amount of carbon dioxide discharged during the manufacturing of the wire harness 100 can be reduced. In addition, since the first rigid board part 22A and the terminals 11 can be electrically connected to each other without using solders, the wire harness 100 can be easily disassembled. Therefore, for example, the wire harness 100 can be easily recycled.

In the wire harness 100 according to the embodiment, the terminal holding part 12 holds the plurality of terminals 11 arranged in a plurality of rows in such a manner that the plurality of terminals 11 in one of the rows adjacent to each other are shifted in the row direction of the plurality of terminals 11 with respect to the plurality of terminals 11 in the other one of the rows adjacent to each other.

In the wire harness 100 according to the embodiment, by arranging the plurality of terminals 11 in one of the rows adjacent to each other to be shifted in a row direction of the plurality of terminals 11 with respect to the plurality of terminals 11 in the other one of the rows adjacent to each other, the metal foil portion of the first flexible printed board part 21A can be linearly drawn out. With this configuration, the circuit layout of one flexible printed board part can be simplified. In addition, the number of terminals 11 connected to one rigid board part can be increased, making it possible to suppress an increase in size of the connector 10 while making the connector 10 multipolar.

In addition, the wire harness 100 according to the embodiment further includes a second planar routing member 20B including a flat plate-shaped second flexible printed board part 21B having flexibility, and a flat plate-shaped second rigid board part 22B connected to one end of the first flexible printed board part 21A, having higher rigidity than the second flexible printed board part 21B, and having a plurality of second through holes TH2 formed therein, in which the plurality of terminals 11 include a first group of terminals arranged on a first side in a direction intersecting the row direction of the plurality of terminals 11 and a second group of terminals arranged on a second side opposite to the first side in the direction intersecting the row direction of the plurality of terminals 11, the press-fit portions 11b of the terminals 11 in the first group of terminals corresponding to the plurality of first through holes TH1 are press-fitted into the plurality of first through holes TH1, respectively, the press-fit portions 11b of the terminals 11 in the second group of terminals corresponding to the plurality of second through holes TH2 are press-fitted into the plurality of second through holes TH2, respectively, the first flexible printed board part 21A extends from the first rigid board part 22A toward the first side, and the second flexible printed board part 21B extends from the second rigid board part 22B toward the second side.

In the wire harness 100 according to the embodiment, by arranging the first planar routing member 20A and the second planar routing member 20B to face each other, the terminals 11 can be press-fitted into the two planar routing members 20 in one step.

The contents disclosed in the above-described embodiment can be executed in appropriate combinations.

The wire harness according to the present embodiment is advantageous in that the load on the environment can be reduced.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

1. A wire harness comprising:
a connector including a plurality of terminals having press-fit portions, and a terminal holding part that holds the plurality of terminals arranged in at least one row in a state where the press-fit portions protrude therefrom; and
a first planar routing member including a flat plate-shaped first flexible printed board part having flexibility, and a flat plate-shaped first rigid board part connected to one end of the first flexible printed board part, having higher rigidity than the first flexible printed board part, and having a plurality of first through holes formed therein to allow the press-fit portions of the terminals corresponding to the plurality of first through holes to be press-fitted into the plurality of first through holes, respectively.

2. The wire harness according to claim 1, wherein
the terminal holding part holds the plurality of terminals arranged in a plurality of rows in such a manner that the plurality of terminals in one of the rows adjacent to each other are shifted in a row direction of the plurality of terminals with respect to the plurality of terminals in the other one of the rows adjacent to each other.

3. The wire harness according to claim 1, further comprising:
a second planar routing member including a flat plate-shaped second flexible printed board part having flexibility, and a flat plate-shaped second rigid board part connected to one end of the second flexible printed board part, having higher rigidity than the second flexible printed board part, and having a plurality of second through holes formed therein, wherein
the plurality of terminals include a first group of terminals arranged on a first side in a direction intersecting the row direction of the plurality of terminals and a second group of terminals arranged on a second side opposite to the first side in the direction intersecting the row direction of the plurality of terminals,
the press-fit portions of the terminals in the first group of terminals corresponding to the plurality of first through holes are press-fitted into the plurality of first through holes, respectively,
the press-fit portions of the terminals in the second group of terminals corresponding to the plurality of second through holes are press-fitted into the plurality of second through holes, respectively,
the first flexible printed board part extends from the first rigid board part toward the first side, and
the second flexible printed board part extends from the second rigid board part toward the second side.

4. The wire harness according to claim 2, further comprising:
a second planar routing member including a flat plate-shaped second flexible printed board part having flexibility, and a flat plate-shaped second rigid board part connected to one end of the second flexible printed board part, having higher rigidity than the second flexible printed board part, and having a plurality of second through holes formed therein, wherein
the plurality of terminals include a first group of terminals arranged on a first side in a direction intersecting the row direction of the plurality of terminals and a second group of terminals arranged on a second side opposite to the first side in the direction intersecting the row direction of the plurality of terminals,
the press-fit portions of the terminals in the first group of terminals corresponding to the plurality of first through holes are press-fitted into the plurality of first through holes, respectively,
the press-fit portions of the terminals in the second group of terminals corresponding to the plurality of second through holes are press-fitted into the plurality of second through holes, respectively,
the first flexible printed board part extends from the first rigid board part toward the first side, and
the second flexible printed board part extends from the second rigid board part toward the second side.
